(19) United States
(12) Patent Application Publication
(10) Pub. No.: US 2025/0229723 A1
(43) Pub. Date: Jul. 17, 2025

(54) Car Luggage Rack With Awning And Method Of Luggage Loading/Unloading

(71) Applicant: Shenzhen Gereiur Technology Co. Ltd., Shenzhen (CN)

(72) Inventors: Jingru Li, Shenzhen (CN); Lei Li, Shenzhen (CN)

(21) Appl. No.: 18/984,987

(22) Filed: Dec. 17, 2024

(30) Foreign Application Priority Data
Jan. 15, 2024 (CN) 202410056288.8

(51) Int. Cl. B60R 9/042; B60J 3/00

(52) U.S. Cl. CPC B60R 9/042; B60J 3/002

(57) ABSTRACT

A car luggage rack includes a base, bottom base, loading frame and extension frame; both ends of the extension frame are pivotally connected to the base and the loading frame respectively, the driving part can drive the extension frame to rotate, further driving the loading frame to extend out of the accommodation space to a predetermined position or to be folded in the accommodation space, the horizontal holding structure is used to maintain a horizontally constant level of the loading frame. This technical solution solves the technical problem in the prior art that users are inconvenient when loading and unloading luggage.

### FIELD OF THE INVENTION

The invention relates to the technical field of luggage racks, specifically to a car luggage rack and method of luggage loading and unloading.

### BACKGROUND OF THE INVENTION

In order to solve the problems of lacking accommodation space in vehicles, vehicle luggage racks came into being. As a car accessory, the car luggage rack can not only increase the amount of luggage that can be loaded in the car, but also can load items that are not suitable for placement in the car. Luggage racks in the prior arts generally only used as a tool to expand the vehicle accommodation space and load more items.

However, with the progress of society and the improvement of people's living standards, different users have different needs for vehicle luggage racks. In addition to the basic function of loading items, the car luggage rack is also expected to have more functions. To this end, the applicant has previously applied for patents on car/vehicle luggage racks (Patent No.: 202410056288.8), aiming to solve the problem of single function of existing car/vehicle luggage racks.

With the development of the market, user demand for products is constantly updated. Base on market investigation, it was found that the products of prior art could no longer meet the market demand, the new demand points are mainly focused on luggage loading. Specifically, they were dissatisfied with the inconvenience of existing luggage racks in loading and unloading luggage onto the roof of the vehicle. Therefore, it is necessary to improve the product of prior arts and propose a brand-new car luggage rack to meet the new marked demand.

### SUMMARY OF THE DISCLOSURE

In view of the shortcomings of the prior arts, the present invention proposes a car luggage rack and method of luggage loading and unloading, so as to solve the problems that users are dissatisfied with the inconvenience of loading or unloading luggage onto the roof of the car.

In order to achieve the above object, the present invention provides a car luggage rack, including:
a base, forming an opening accommodation space;
a bottom base, which is provided in the accommodation space and maintains a certain gap with the bottom of the accommodation space;
a loading frame, forming a loading space with the loading bottom and the open top;
a extension frame with its two ends pivotally connected to the base and the loading frame respectively;
a driving part, driving the extension frame to rotate, further driving the loading frame to extend out of the accommodation space to a predetermined position or to be folded in the accommodation space;
a horizontal holding structure, used to keep the loading frame horizontally constant when the driving part drives the loading frame to extend out of the accommodation space or being folded into the accommodation space.

Preferably, the base includes a left longitudinal beam and a right longitudinal beam arranged oppositely; both ends of the left longitudinal beam and the right longitudinal beam are provided with installation opening adapted to the longitudinal rail on the top of the vehicle.

Based on the above technical solution, when the loading frame extends out of the accommodation space or being folded into the accommodation space, the loading frame is always be presented parallel to the horizontal plane, and the loading frame can be sent to a predetermined position. It solves the technical problem in the prior arts that users are inconvenient when loading and unloading luggage.

Furthermore, the loading frame includes a left longitudinal bar, a right longitudinal bar arranged oppositely and crossbar group connecting the left longitudinal bar and right longitudinal bar; the loading bottom is formed by the left longitudinal bar, the right longitudinal bar and the crossbar group together;

The crossbar group includes the fixed crossbar and the movable crossbar; the two ends of the fixed crossbar are fixedly connected to the left longitudinal bar and the right longitudinal bar respectively; the movable cross bar is fixedly connected to the left longitudinal bar and the right longitudinal bar respectively, and is pivotally connected to the extension frame.

Furthermore, the extension frame includes:
the extension arm, which is provided with a spline hole at one end and is key connected to the output shaft of the driving part; the other end is provided with a first through hole and is pivotally connected with the loading frame;

Preferably, the extension frame further includes a cover, which is provided outside the extension arm and an assembly space for assembling the horizontal holding structure is formed inside.

Furthermore, the horizontal holding structure is provided in the assembly space, and the horizontal holding structure includes:
a first sprocket and the a second sprocket, which are arranged respectively at both ends of the assembly space; the first sprocket is rotationally connected to the output shaft of the driving part, the second sprocket is fixedly connected to the base;
a chain, which is meshed with the first sprocket and the second sprocket on the same side at the same time;

The output shaft of the driving part extends from the spline hole into the cover, passes through the center hole of the first sprocket and is rotationally connected to the base.

Furthermore, a plurality of circumferentially spaced rivet posts are provided on the end face of the first sprocket facing to the base. one end of the rivet post is fixedly connected to the first sprocket, and the other end extends out of the cover and is fixedly connected to the base.

Furthermore, a relief notch is formed along the length direction of the base, and the relief notch is located on the side of the bottom base close to the base; based on the setting of the relief notch, the bottom base is formed an upper end surface with a width of W₁ and a relief notch with a depth of D₁ and a width of W₂;
The width of the extension arm is W₃;
The height difference between the lower end surface of the extension arm and the lower end surface of the cover is H₁;
The width of the left longitudinal bar and the right longitudinal bar of the loading frame is W₄ and the height is H₂;
The width of the cover is W₅;
When the extension frame and the loading frame are folded in the accommodation space, D₁≥H₁, W₃+W₄<W₁, W₂≥W₅.

Furthermore, the pressure-bearing base is provided at the front end of the base; the upper end surface of the pressure-bearing base is provided with a notch adapted to the movement trajectory of the extension arm;

Preferably, the pressure-bearing base includes the upper end surface and the notch end surface formed based on the notch; the upper end surface of the pressure-bearing base and the notch end surface are both inclined surfaces;

Further preferably, the width of the notch is W₆ and the depth is D₂; the width of the upper end surface of the pressure-bearing base is W₇, wherein, W₅<W₆;

Further preferably, the upper end surface of the pressure-bearing base is parallel to the notch end surface and D₂=H₁.

Furthermore, at least one side of the base is provided with an awning; the awning includes:
a shell including a shell wall and an accommodation cavity defined by the shell wall;
a opening communicates with the accommodation cavity and is provided on one side wall of the shell;
a shielding component;
a driving component, which is used to drive the shielding component to fold and unfold, in order to form a shielding barrier at a predetermined position.

The present invention also provides a luggage loading and unloading method, comprising:

Along the arc path with the driving part as the center and the length of the extension frame as the radius, the loading frame is sent to a predetermined low position in horizontal or being folded together with the extension frame in the accommodation space.

Furthermore, the luggage loading and unloading method includes:
Unloading steps: the driving part drives the extension frame to rotate around the output shaft of the driving part to lift the loading frame horizontally; continuing to drive the extension frame to rotate, horizontally lowering the loading frame to the side of the vehicle, keeping the height of the loading frame lower than the height of the vehicle roof;
Loading steps: the driving part drives the extension frame to rotate reversely around the output shaft of the driving part and lift the loading frame horizontally; continuing to drive the extension frame to rotate in the opposite direction, lowering the loading frame horizontally, and being folded together with the extension frame in the accommodation space.

This method enables the loading frame always be presented parallel to the horizontal plane, and the loading frame can be sent to a predetermined position. It solves the technical problem in the prior art that users are inconvenient when loading and unloading luggage.

### BRIEF DESCRIPTION OF THE DRAWINGS

FIG. 1 is a schematic view of the car luggage rack under folded state.

FIG. 2 is a schematic view of the car luggage rack under unfolded state.

FIG. 3 is a schematic view of an embodiment of the loading frame.

FIG. 4 is a schematic view of an embodiment of the extension arm.

FIG. 5 is a schematic view of an embodiment of the horizontal holding structure.

FIG. 6 is a schematic view of an embodiment of the driving part.

FIG. 7 is a schematic view of an embodiment of the bottom base.

FIG. 8 is a view of an embodiment of the assembly relationship between the extension arm and the cover.

FIG. 9 is a schematic view of FIG. 8 from another angle.

FIG. 10 is a schematic view of an embodiment of the pressure-bearing base.

FIG. 11 is a schematic view of the car luggage rack when it is assembled on the vehicle roof.

FIG. 12 is a schematic view of an embodiment of the awning.

FIG. 13 is a schematic view of FIG. 12 without the shielding component.

FIG. 14 is a partial schematic view of an embodiment of the rolling part.

FIG. 15 is a partial schematic view of the interior of the awning.

FIG. 16 is a partial schematic view of an embodiment of the driving part.

FIG. 17 is a schematic view of the car luggage rack under state of use.

### DETAILED DESCRIPTION OF THE PREFERRED EMBODIMENTS

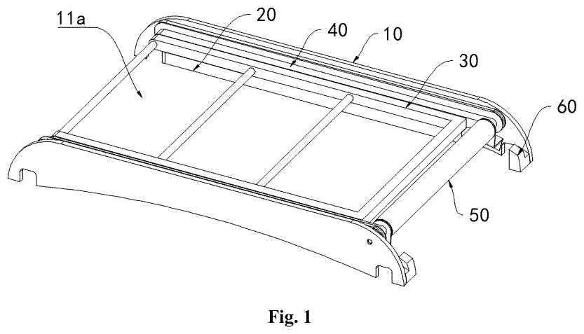

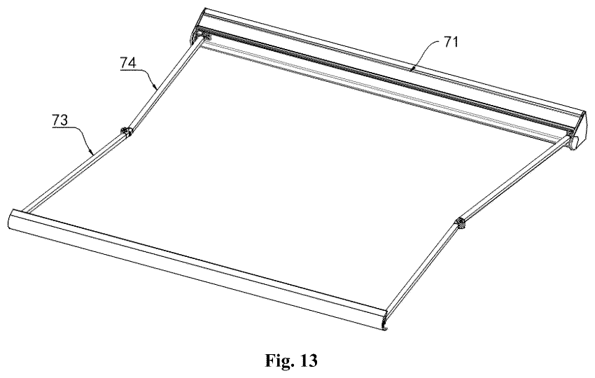

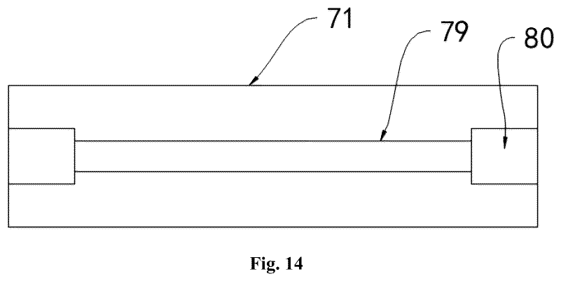

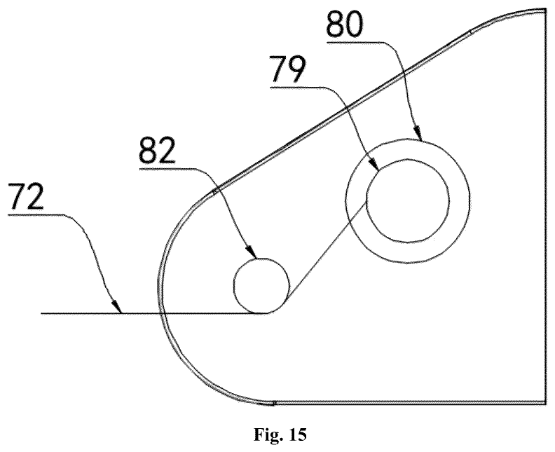

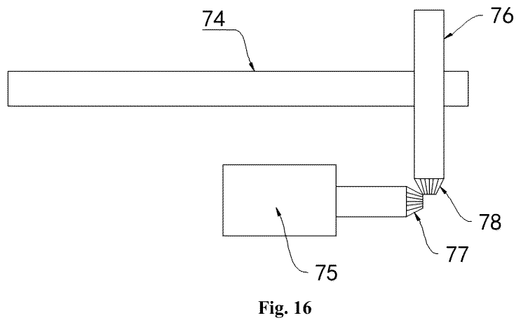

Other features, objects and advantages of the present invention will be more clearly and completely by the detailed description of the non-limiting embodiments with reference to the attached drawings (FIG. 1 to FIG. 17).

In the present invention, unless otherwise stated, it should be noted that the terms “provided” and “connected” should be understood broadly. For example, “connected” could be fixed connection, detachable connection, integral connection, mechanical connection, electrical connection, direct connection, indirect connection through the intermediate structure, or internal connection between two elements.

In the present invention, the use of orientation words such as “upper”, “lower”, “inside”, “outside” are only for the convenience of description, rather than indicating or implying the specific orientation, therefore it should not be construed as being limited to the description of the following embodiments.

In the present invention, the terms “comprises/including” and the like in the description of the present invention and the attached drawings are used to describe the technical features, numerical values, steps or components. One or more other features, numerical values, steps, components or their combinations based on this invention shall be included in the scope of protection of the present invention.

### Embodiment 1

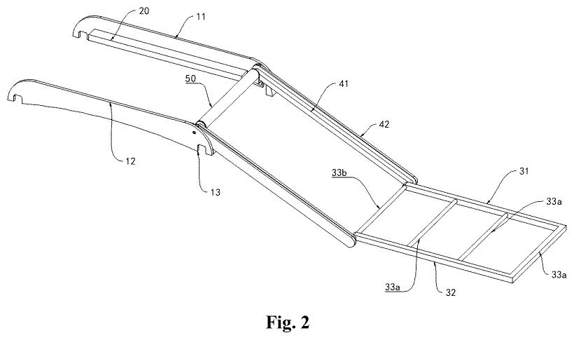

As shown in FIGS. 1 and 2, the car luggage rack includes a base 10, a bottom base 20, a loading frame 30, an extension frame 40, a driving part 50 and a horizontal holding structure.

The base 10 is formed an open accommodation space 11a, the bottom base 20 is provided in the accommodation space 11a and maintains a certain gap from the bottom of the accommodation space 11a. The loading frame 30 is formed a loading space with the loading bottom and the opening top. Both ends of the extension frame 40 are pivotally connected to the base 10 and the loading frame 30 respectively. The driving part 50 is used for driving the extension frame 40 to rotate, further driving the loading frame 30 to extend out of the accommodation space 11a to a predetermined position or to be folded in the accommodation space 11a. The horizontal holding structure is used to keep the loading frame 30 horizontally constant when the driving part 50 drives the loading frame 30 to extend out of the accommodation space 11a or being folded into the accommodation space 11a.

Based on the above technical solution, when the loading frame 30 extends out of the accommodation space 11a or being folded in the accommodation space 11a, the loading frame 30 always presents parallel to the horizontal plane, and the loading frame 30 can be sent to a predetermined position. It solves the technical problem in the prior art that users are inconvenient when loading and unloading luggage.

During use, the base 10 can be installed on the longitudinal rail on the top of the vehicle through a mounting structure, such as a clamp, bolts and nuts, etc. In an optional implementation, as shown in FIG. 2, the base 10 includes a left longitudinal beam 11 and a right longitudinal beam 12 arranged oppositely. Both ends of the left longitudinal beam 11 and the right longitudinal beam 12 are provided with installation openings 13 that are adapted to the longitudinal rails on the top of the vehicle. The purpose of providing the installation opening 13 is to facilitate the installation of the base 10.

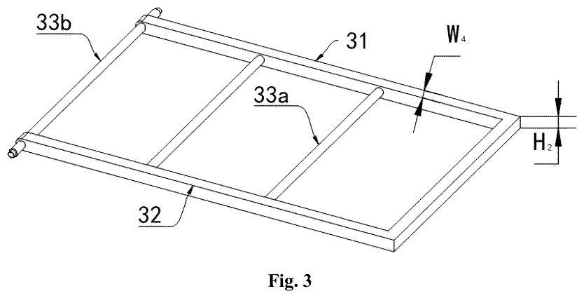

As shown in FIGS. 2 and 3, the loading frame 30 includes a left longitudinal bar 31, a right longitudinal bar 32 oppositely arranged, and a crossbar group connecting the left longitudinal bar 31 and the right longitudinal bar 32. The loading bottom is formed with the left longitudinal bar 31, the right longitudinal bar 32 and the crossbar group together.

The crossbar group includes the fixed crossbar 33a and the movable crossbar 33b. Both ends of the fixed crossbar 33a are fixedly connected to the left longitudinal bar 31 and the right longitudinal bar 32 respectively. Both ends of the movable crossbar 33b are fixedly connected to the left longitudinal bar 31 and the right longitudinal bar 32 respectively and are pivotally connected to the extension frame 40.

The movable crossbar 33b is not only a part of the bottom of the loading space, but also an important component for realizing the rotational connection between the loading frame 30 and the extension frame 40. That is, two functions are simultaneously realized through one component, and no additional rotating shaft is needed to support the rotational connection between the loading frame 30 and the extension frame 40, which improves space utilization and saves the cost of parts.

It should be noted that the movable cross bar 33b does not rotate itself, that is, there is no relative rotation between the movable cross bar 33b, the left longitudinal bar 31 and the right longitudinal bar 32. While the two ends of the movable cross bar 33b are fixedly connected to the left longitudinal bars 31 and right longitudinal bars 32, a part of movable cross bar 33b extends out and is pivotally connected to the extension frame 40. The pivot connection is achieved via bearings. Specifically, the bearings are sleeved on both ends of the movable crossbar 33b, the inner ring of the bearing is fixedly connected to the movable crossbar 33b, and the outer ring is fixedly connected to the extension frame 40, thereby the pivot connection could be realized.

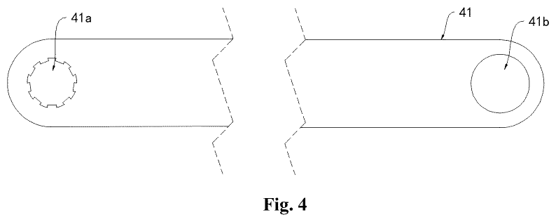

As shown in FIGS. 2 and 4, the extension frame 40 includes an extension arm 41. One end of the extension arm 41 is provided with a spline hole 41a and is key connected to the output shaft of the driving part 50. A first through hole 41b is provided at the other end of the extension arm 41, and the extension arm 41 is pivotally connected to the loading frame 30. It should be noted that one end of the extension arm 41 provided with spline hole 41a is the rotation force-receiving end.

It should be noted that the “pivotal connection” here refers to the “pivotal connection between the movable cross bar 33b and the extension frame 40” mentioned above. A hole may be provided at the pivotal connection between the loading frame 30 and the extension arm 41, the bearing is provided in the hole, and the outer ring of the bearing is fixedly connected to the inner wall of the hole.

As shown in FIGS. 1 and 2, the extension frame 40 further includes a cover 42. The cover 42 is provided on the outside of the extension arm 41, and an assembly space for assembling the horizontal holding structure is formed inside, the specific structure and working method of the horizontal holding structure will be described in detail later. Installing the horizontal holding structure in the assembly space formed by the cover 42, on the one hand, protect the horizontal holding structure from being exposed to the outside, which may affect its performance due to wind, water, sun, rain, snow, etc.; on the other hand, it can improve the overall aesthetics of the equipment, mechanical structures that are not in line with the public's aesthetics can be hidden in the cover 42. In general, providing the cover 42 can improve the aesthetics of appearance, extend the service life of the equipment and increase the load-bearing capacity of the extension frame 40. Therefore, the present invention fully considers and optimizes the structural arrangement of the extension frame 40 and the horizontal holding structure, and achieves a clever combination of functionality and aesthetics.

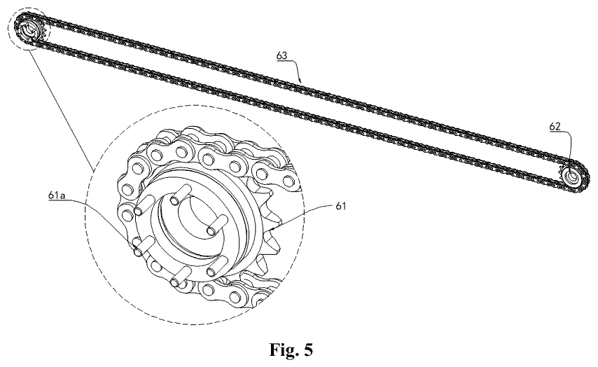

As shown in FIG. 5, the horizontal holding structure includes the first sprocket 61, the second sprocket 62 and the chain 63. The first sprocket 61 and the second sprocket 62 are respectively provided at both ends of the assembly space. The first sprocket 61 is rotatably connected to the output shaft of the driving part 50, the second sprocket 62 is fixedly connected to the base 10. The chain 63 is meshed with the first sprocket 61 and the second sprocket 62 on the same side at the same time. The output shaft of the driving part 50 extends from the spline hole 41a into the cover 42, passes through the center hole of the first sprocket 61 and is rotationally connected to the base 10.

In the selection of the driving part 50, two motors may be provided to drive the left and right extension arms 41 respectively. The motor can be installed on the base 10 through the motor base. Considering the problem of synchronization, if two motors are provided to drive the left and right extension arms respectively, the two motors cannot rotate in synchronization, the left and right parts of the extension frame will generate shear force, therefore cause the tilting of loading frame. The occurrence of these situations will lead to equipment failure and difficulty in luggage loading and unloading.

Therefore, in a preferred embodiment of the present invention, as shown in FIG. 2, a dual-axis motor is selected as the driving part 50. The two output shafts of the dual-axis motor drive the two extension arms 41 respectively. This can achieve rotational synchronization during use and avoid the above-mentioned situation. At the same time, due to the dual-axis motor itself has a certain load-bearing capacity, it is equivalent to providing a connecting member to connect the two left and right extension arms 41 together, thereby increasing the stability of the extension frame 40.

Considering the higher cost of dual-axis motors, the single-axis motor can be used. Specifically, gear A is provided on the output shaft of the single-axis motor, and two rotating shafts are provided at the same time. The two rotating shafts are collinear and opposite to each other. One end of the two rotating shafts is key connected to the spline hole 41a respectively, and the other end is provided with gear B, gear B is meshed with gear A. In this way, two rotating shafts can be driven simultaneously and synchronously through the single-axis motor, thereby achieving synchronization of rotation.

It should be noted that reducer is provided in the above-mentioned motors, dual-axis motors, and single-axis motors.

Stop the extension frame 40 driven by the driving part 50 can be realized through the controller, and the corresponding control program is pre-introduced into the controller. For example, the motor stops when it rotates a fixed angle, or stops when it rotates for a fixed duration. Of course, induction switches electrically connected to the motor can also be provided on the pressure-bearing base 60 and the bottom base 20. When the cover 42 comes into contact with the induction switch, the motor stops running.

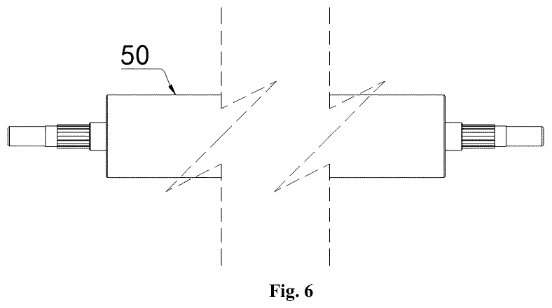

In the horizontal holding structure, it should be further explained that the output shaft of the driving part 50 is a spline shaft and is key connected to the spline hole 41a. The output shaft of the driving part 50 passes through the central hole of the first sprocket 61 and is rotationally connected to the central hole but not fixedly connected. The output shaft of the driving part 50 further extends and is rotationally connected with the base 10. Therefore, as shown in FIG. 6, in the configuration of the driving part 50, it is preferable not to provide splines on the entire output shaft, but to arrange the splines near the end of the output shaft, and the end of the output shaft is provide as smooth shaft. In addition, the aforementioned “rotational connection” can be achieved by installing bearings.

Based on the characteristics of servo motor, which can precisely control the angular velocity, line position, speed and acceleration. Preferably, the motor is provided as servo motor.

It can be seen from this that the driving part 50 does not drive the first sprocket 61 to rotate. In other words, the first sprocket 61 does not rotate itself no matter what state it is in, the first sprocket 61 is fixedly connected to the base 10 and is rotationally connected to the output shaft of the driving part 50.

Specifically, the first sprocket 61 is fixedly connected to the base 10 as follows: as shown in FIG. 5, a plurality of circumferentially spaced rivet posts 61a are provided on the end face of the first sprocket 61 facing to the base 10. One end of the rivet post 61a is fixedly connected to the first sprocket 61, and the other end extends out of the cover 42 and is fixedly connected to the base 10.

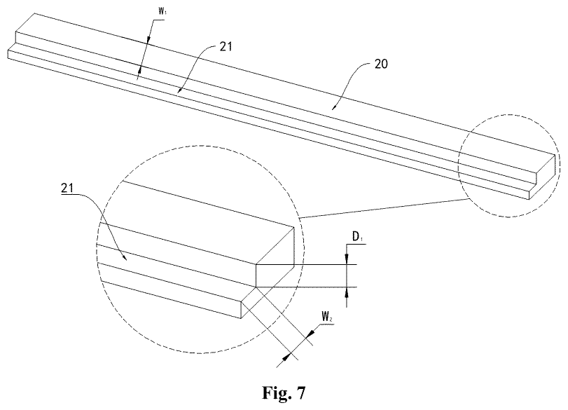

As shown in FIGS. 2 and 7, the bottom base 20 is formed with a relief notch 21 along its length direction. The relief notch 21 is located on the side of the bottom base 20 close to the base 10. Based on the setting of the relief notch 21, the bottom base 20 is formed an upper end surface with a width W, and a relief notch 21 with a depth D₁ and a width W₂.

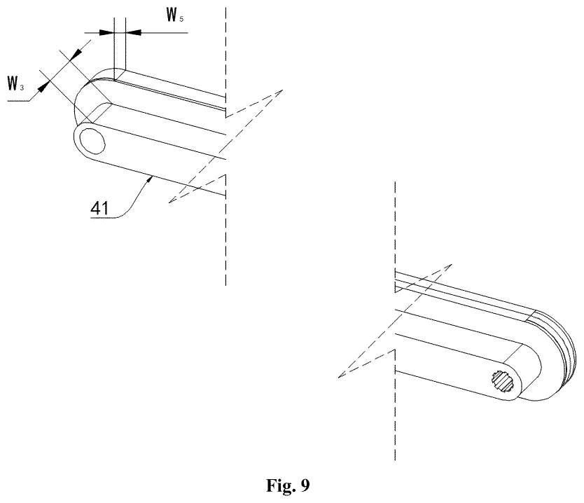

As shown in FIG. 9, the width of the extension arm 41 is W₃. The height difference between the lower end surface of the extension arm 41 and the lower end surface of the cover 42 is H₁. The width of the left longitudinal bar 31 and the right longitudinal bar 32 of the loading frame 30 is W₄ and the height is H₂. The width of the cover 42 is W₃. When the extension frame 40 and the loading frame 30 are folded in the accommodation space, D₁≥H₁, W₃+W₄<W₁, W₂≥W₅.

In this way, when the extension frame 40 and the loading frame 30 are folded in the accommodation space 11a, the cover 42 below the extension arm 41 just falls within the relief notch 21. The extension arm 41 and the longitudinal bars on both sides of the loading frame 30 fall on the upper end surface of the bottom base. This ensures that the loading frame 30 and the extension frame 40 are folded in the accommodation space 11a in horizontal and that there is no interference between the various structures. Therefore, based on such structural arrangement and layout, the overall equipment is more compact and occupies less space.

Under a certain load, the stress of the chain 63 is inversely proportional to the radius of the sprocket. Therefore, the sprocket should be appropriately selected as large as possible. Therefore, the size of the cover 42 mentioned above is larger than the size of the extension arm 41, on the one hand, to ensure that the loading frame 30 and the extension frame 40 can be folded horizontally in the accommodation space 11a without interference between the various structures, on the other hand, the cover 42 can create as large assembly space as possible to accommodate sprocket as large as possible.

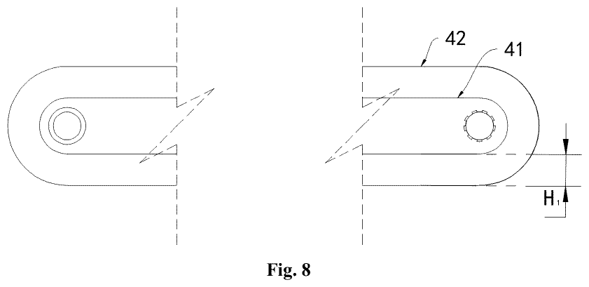

Therefore, there are two requirements of “the cover 42 can create as large assembly space as possible” and “to ensure that the loading frame 30 and the extension frame 40 can be folded horizontally in the accommodation space 11a without interference between the various structures”, which results in the special structural arrangement between the cover 42 and the extension arm 41. As shown in FIGS. 2 and 8, the cover 42 and the extension arm 41 form a T-shaped cross-section, and the orthographic projection of the extension arm 41 all falls within the cover 42.

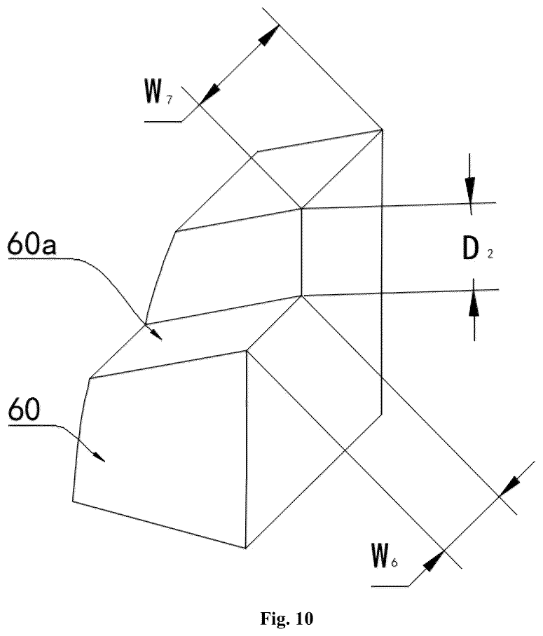

As shown in FIGS. 1 and 2, a pressure-bearing base 60 is provided at the front end of the base 10. As shown in FIG. 10, the upper end surface of the pressure-bearing base 60 is provided with a notch 60a adapted to the movement trajectory of the extension arm 41. The pressure-bearing base 60 is provided to prevent the force-bearing point of the cover 42 from falling on the vehicle, thereby damaging the paint surface or metal plate of the vehicle.

In a preferred embodiment, the pressure-bearing base 60 includes the upper end surface and the notch end surface formed based on the notch 60a. The upper end surface and the notch end surface of the pressure-bearing base 60 are both inclined surfaces. Preferably, the width of the notch 60a is W₆ and the depth is D₂, the width of the upper end surface of the pressure-bearing base 60 is W₇, wherein, W₅<W₆.

The arrangement of the inclined surface allows the extension arm 41 and the pressure-bearing base 60 to have a larger stress-bearing area, thereby alleviating excessive stress concentration on the extension arm 41.

Further preferably, the upper end surface of the pressure-bearing base 60 is parallel to the notch end surface and D₂=H₁. In this way, when the extension frame 40 is in the unfolded state, the force-bearing point of the cover 42 is exactly located on the end surface of the notch, and the force-bearing point of the extension arm 41 is exactly located on the upper end surface of the pressure-bearing base 60. The arrangement based on multiple force-bearing points can greatly improve the luggage loading capacity when the extension frame 40 and the loading frame 30 are in the unfolded state.

In a preferred embodiment, the base 10, the bottom base 20, the loading frame 30 and the extension frame 40 are all made of hollow aluminum alloy. Aluminum alloy has a lower density than other metals, so it can reduce the weight of the luggage rack and achieve lightweight. At the same time, aluminum alloy also has very good strength, ensuring the firmness and good load-bearing capacity of the luggage rack. In addition, the hollow structure can provide space for hidden assembly of other components.

In order to improve the carrying capacity of the loading frame 30 when the luggage rack is in the unfolded state, an accommodating groove for accommodating the support legs is provided at the bottom of the loading frame 30. The support legs are telescopic rods, one end of which is hinged with the bottom of the loading frame 30. When the luggage rack is in the unfolded state, the telescopic legs can be released from the accommodating grooves so that the other ends of the telescopic legs are supported on the ground.

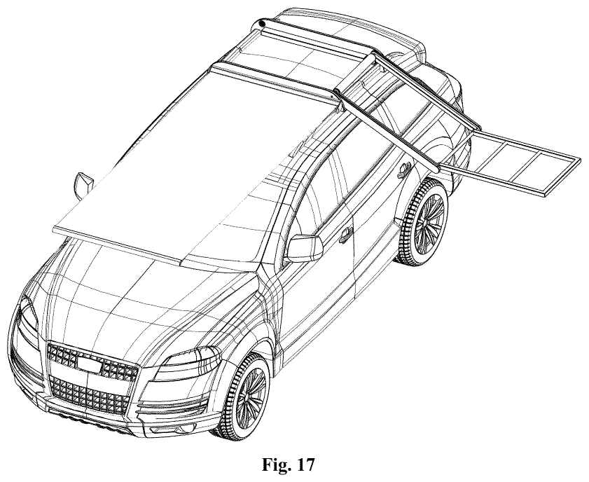

Furthermore, an awning is provided on at least one side of the base 10. The awning can block the sun, reduce the temperature inside the vehicle, and can also block rain, snow and leaves. It should be noted that the “side of the base 10” here should be distinguished from the front and rear ends of the base 10. As shown in FIG. 17, the “side of the base 10” corresponds to the front or rear end of the vehicle.

Considering that whether it is a SUV or a car, the horizontality of the front windshield is generally greater than that of the rear windshield, sunlight mainly enters the car through the front windshield. Therefore, it is preferable to provide an awning only on the side of the base 10 facing to the front of the vehicle. The awning can be fixedly connected to the base 10, or can be installed on the longitudinal rail on the top of the vehicle through a mounting structure.

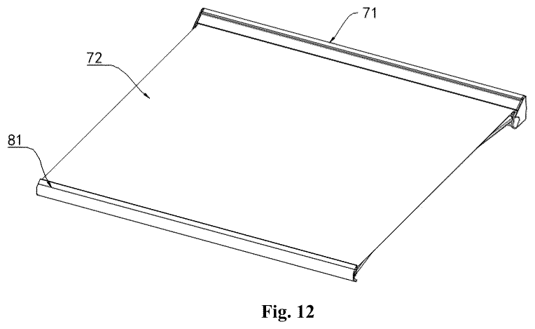

As shown in FIGS. 12-16, the awning includes a shell 71, an opening, a shielding component 72 and a driving component. The shell 71 includes a shell wall and an accommodation cavity formed by the shell wall. The opening communicates with the accommodation cavity and is provided on one side wall of the shell 71. The driving component is used to drive the folding and unfolding of shielding component 72, in order to form a shielding barrier at the predetermined position.

The shielding component 72 is made of flexible material sunshade cloth, which can be easily stored in the accommodation cavity. The driving component includes: a telescopic part, a motor 75 and a rolling part. One end of the shielding component 72 is connected to the telescopic part. The telescopic part includes the first driving rod 73 and the second driving rod 74. One end of the first driving rod 73 is connected to one end of the shielding component 72, one end of the second driving rod 74 is hingedly connected to the other end of the first driving rod 73. The end of the second driving rod 74 away from the hinge is provided with a rotating shaft 76, the rotating shaft 76 is sleeved with the driven gear 78, and the output shaft of the motor 75 is provided with the driving gear 77 meshed with the driven gear 78. The rolling part is connected to the other end of the shielding component 72 and is used to roll up the shielding component 72.

When sun shading is required, the motor 75 is started to drive the driven gear 78 and rotating shaft 76 to rotate, then drive the second driving rod 74 and the first driving rod 73 to rotate and unfold, and the sun shading component 72 is extended out of the shell 71.

The rolling part includes a rolling drum 79. The rolling drum 79 is rotatably connected to the inner wall of the shell 71 through a rolling sleeve 80. The rolling sleeve 80 is connected to the rolling drum 79 through the flat spiral spring provided inside. The rolling drum 79 is connected to one end of the shielding component 72.

Through the above arrangement, when the shielding component 72 extends out of the shell 71, the flat spiral spring will be tightened. When the shielding component 72 is folded, the flat spiral spring will gradually return to its original position, driving the rolling drum 79 to rotate and roll up the shielding component 72.

Furthermore, a cover body 81 capable of opening or closing is hinged on one end of the first driving rod 73 away from the hinged connection with the second driving rod 74. Based on the arrangement of the cover body 81, when the awning is not in use, the opening can be closed by the cover body 81 to improve the sealing performance of the equipment and prevent rainwater and dust particles from entering the shell.

Furthermore, the awning is also provided with a tensioning wheel 82, which can tighten the shielding component 72 so that the shielding component 72 can be rolled up more smoothly.

The awning can unfold the shielding component 72 stored in the shell 71 through the driving component, so that the shielding component 72 forms a shielding barrier above the front windshield of the vehicle, reducing sunlight shining and lowering the temperature inside the vehicle.

### Embodiment 2

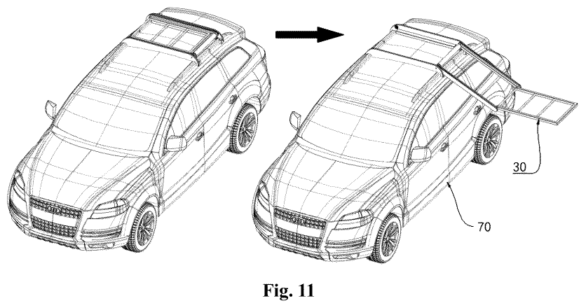

The present invention provides a car. As shown in FIG. 11, the car includes the car body and the car luggage rack. The car luggage rack is provided on the top of the car body 70. The front end of the luggage rack faces the side of the car body 70. It should be noted that the “front end” specifically refers to the unfolding direction of the loading frame 30 and the extension frame 40 of the car luggage rack.

### Embodiment 3

The present invention provides a luggage loading and unloading method. Generally speaking, along an arc path defined by the driving part 50 as the center and the length of the extension frame 40 as the radius, the loading frame 30 is sent horizontally to a predetermined low position or to be folded together with the extension frame 40 in the accommodation space 11a.

It should be emphasized that the loading frame 30 is not in a horizontal attitude at a certain point or period of time, but is in a horizontal attitude throughout the entire process.

It should be noted that the specific position of “predetermined low position” can be determined according to actual needs. There are many factors that affect the “predetermined low position”, including the length of the extension frame 40, the material strength of the extension frame 40 and the loading frame 30, the maximum tilt angle of the extension frame 40, and so on. Preferably, the predetermined low position is 0.5 m to 1 m above the ground.

Specifically, the luggage loading and unloading method includes the unloading step and the loading step. The unloading step includes: driving the extension frame 40 to rotate around the output shaft of the driving part 50 through the driving part 50, horizontally lifting the loading frame 30, continuing to drive the extension frame 40 to rotate, horizontally lowering the loading frame 30 to the side of the vehicle, keeping the height of the loading frame 30 lower than the height of the vehicle roof. The loading step includes: driving the extension frame 40 to reversely rotate around the output shaft of the drive part 50 through the driving part 50, horizontally lifting the loading frame 30, continuing to drive the extension frame 40 to reversely rotate, horizontally lowering the loading frame 30, and folded together with the extension frame 40 in the accommodation space 11a.

As shown in FIG. 1, when luggage needs to be loaded, the extension arm 40 is driven by the driving part 50 to rotate with the output shaft of the driving part 50. Due to one end of the extension arm 41 is hinged with the loading frame 30, under the action of horizontal holding structure, the loading frame 30 will be driven to be lifted horizontally. By continuing to drive the extension frame 40 to rotate, the loading frame 30 will be lowered horizontally again. It should be noted that the movement of the loading frame 30 is not simply up and down movement in the vertical direction, but an arc movement with the driving part 50 as the center and the extension frame 40 as the radius while maintaining a horizontal attitude. The final point of the loading frame 30 is at the side of the vehicle and the height is lower than the top of the vehicle.

The loading frame 30 is placed at a predetermined low position on the side of the vehicle, which not only facilitates the user to load or unload luggage in terms of height, but also provides the user with more operating space when loading and unloading luggage.

For traditional luggage racks, the user will inevitably come into contact with the vehicle when loading and unloading luggage. On the one hand, there are certain difficulties in loading and unloading, on the other hand, it is easy for luggage to hit or scratch the vehicle.

The luggage loading and unloading method also includes: when the driving part 50 drives the extension frame 40 close to the bottom base 20 or the pressure-bearing base 60, decelerate the extension frame 40, that is, reduce the rotation speed of the driving part 50. The purpose is, on the one hand, to prevent the extension frame 40 from over-rotating, reduce the instantaneous load on the driving part 50 and protect the driving part 50. On the other hand, it is possible to prevent the extension frame 40, the loading frame 30 and the luggage from moving due to an emergency stop, and at the same time, it is also possible to prevent strong collisions between the extension frame 40, the bottom base 20 and the pressure-bearing base 60.

Furthermore, a buffer rubber layer of uniform thickness can be provided on the surfaces of the bottom base 20 and the pressure-bearing base 60 to reduce impact.

It should be noted that, the embodiments and features in the present invention can be combined with each other without conflict, the above-mentioned multiple embodiments described can be combined arbitrarily according to actual needs. Any combination, equivalent replacement or modification would fall within the protection scope of the present invention. All the above-mentioned drawings are exemplary illustrations of the present invention and do not represent the actual size of the product, and the dimensional proportional relationship between the components in the drawings is not intended to limit the actual product of the present invention.

What is claimed is:

1. A car luggage rack comprising:
a base (10), forming an opening accommodation space (11a);
a bottom base (20), which is provided in the accommodation space (11a) and maintains a certain gap with the bottom of the accommodation space (11a);
a loading frame (30), forming a loading space with the loading bottom and the open top;
an extension frame (40) with its two ends pivotally connected to the base (10) and the loading frame (30) respectively;
a driving part (50), driving the extension frame (40) to rotate, further driving the loading frame (30) to extend out of the accommodation space (11a) to a predetermined position or to be folded in the accommodation space (11a);
a horizontal holding structure, used to keep the loading frame (30) horizontally constant when the driving part (50) drives the loading frame (30) to extend out of the accommodation space (11a) or being folded into the accommodation space (11a);
wherein the base (10) includes a left longitudinal beam (11) and a right longitudinal beam (12) arranged oppositely; both ends of the left longitudinal beam (11) and the right longitudinal beam (12) are provided with installation opening (13) adapted to the longitudinal rail on the top of the vehicle.

2. The car luggage rack according to claim 1, wherein the loading frame (30) includes a left longitudinal bar (31), a right longitudinal bar (32) arranged oppositely and crossbar group connecting the left longitudinal bar (31) and right longitudinal bar (32); loading bottom is formed by the left longitudinal bar (31), the right longitudinal bar (32) and the crossbar group together; said crossbar group includes the fixed crossbar (33a) and the movable crossbar (33b); the two ends of the fixed crossbar (33a) are fixedly connected to the left longitudinal bar (31) and the right longitudinal bar (32) respectively; the movable cross bar (33b) is fixedly connected to the left longitudinal bar (31) and the right longitudinal bar (32) respectively, and is pivotally connected to the extension frame (40).

3. The car luggage rack according to claim 1, wherein the extension frame (40) includes: an extension arm (41), which is provided with a spline hole (41a) at one end and is key connected to the output shaft of the driving part (50); the other end is provided with a first through hole (41b) and is pivotally connected with the loading frame (30); and the extension frame (40) further includes a cover (42), which is provided outside the extension arm (41) and an assembly space for assembling the horizontal holding structure is formed inside.

4. The car luggage rack according to claim 3, wherein the horizontal holding structure is provided in the assembly space, and the horizontal holding structure includes:
a first sprocket (61) and a second sprocket (62), which are arranged respectively at both ends of the assembly space; the first sprocket (61) is rotationally connected to the output shaft of the driving part (50), the second sprocket (62) is fixedly connected to the base (10);
a chain (63), which is meshed with the first sprocket (61) and the second sprocket (62) on the same side at the same time;
an output shaft of the driving part (50) extends from the spline hole (41a) into the cover (42), passes through the center hole of the first sprocket (61) and is rotationally connected to the base (10).

5. The car luggage rack according to claim 3, wherein a plurality of circumferentially spaced rivet posts (61a) are provided on the end face of the first sprocket (61) facing to the base (10), one end of the rivet post (61a) is fixedly connected to the first sprocket (61), and the other end extends out of the cover (42) and is fixedly connected to the base (10).

6. The car luggage rack according to claim 3, wherein a relief notch (21) is formed along the length direction of the base (20), and the relief notch (21) is located on the side of the bottom base (20) close to the base (10); based on the setting of the relief notch (21), the bottom base (20) is formed the upper end surface with a width of W₁ and the relief notch (21) with a depth of D₁ and a width of W₂; the width of the extension arm (41) is W₃; the height difference between the lower end surface of the extension arm (41) and the lower end surface of the cover (42) is H₁; the width of the left longitudinal bar (31) and the right longitudinal bar (32) of the loading frame (30) is W₄ and the height is H₂; the width of the cover (42) is W₅; and when the extension frame (40) and the loading frame (30) are folded in the accommodation space, D₁≥H₁, W₃+W₄<W₁, W₂≥W₅.

7. The car luggage rack according to claim 6, wherein the pressure-bearing base (60) is provided at the front end of the base (10); the upper end surface of the pressure-bearing base (60) is provided with a notch (60a) adapted to the movement trajectory of the extension arm (41); said pressure-bearing base (60) includes the upper end surface and the notch end surface formed based on the notch (60a); the upper end surface of the pressure-bearing base (60) and the notch end surface are both inclined surfaces; the width of the notch (60a) is W₆ and the depth is D₂; the width of the upper end surface of the pressure-bearing base (60) is W₇, wherein, W₅<W₆; the upper end surface of the pressure-bearing base (60) is parallel to the notch end surface and D₂=H₁.

8. The car luggage rack according to claim 1, wherein at least one side of the base (10) is provided with an awning; the awning includes:
a shell (71), including a shell wall and an accommodating cavity defined by the shell wall;
a opening communicates with the accommodation cavity and is provided on one side wall of the shell (71);
a shielding component (72);
a driving component, which is used to drive the shielding component (72) to fold and unfold, in order to form a shielding barrier at a predetermined position.

9. A luggage loading and unloading method for the car luggage rack comprising:
along the arc path with the driving part (50) as the center and the length of the extension frame (40) as the radius, the loading frame (30) is sent to a predetermined low position in a horizontal attitude or being folded together with the extension frame (40) in the accommodation space (11a).

10. The luggage loading and unloading method according to claim 9, wherein in an unloading step: the driving part (50) drives the extension frame (40) to rotate around the output shaft of the driving part (50) to lift the loading frame (30) horizontally; continuing to drive the extension frame (40) to rotate, horizontally lowering the loading frame (30) to the side of the vehicle, keeping the height of the loading frame (30) lower than the height of the vehicle roof; and in a loading step: the driving part (50) drives the extension frame (40) to rotate reversely around the output shaft of the driving part (50) and lift the loading frame (30) horizontally; continuing to drive the extension frame (40) to rotate in the opposite direction, lowering the loading frame (30) horizontally, and being folded together with the extension frame (40) in the accommodation space (11a).
